(19) United States
(12) Patent Application Publication
(10) Pub. No.: US 2008/0080167 A1
(43) Pub. Date: Apr. 3, 2008

(54) DIRECT TYPE BACKLIGHT MODULE WITH ONE-PIECE HEAT DISSIPATING HOUSING

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,618

(22) Filed: Dec. 28, 2006

(30) Foreign Application Priority Data
Sep. 29, 2006 (CN) 200610200960.8

(51) Int. Cl. G09F 13/04

(52) U.S. Cl. 362/97

(57) ABSTRACT

An exemplary direct type backlight module (20) includes a one-piece housing (21), at least one circuit board (23), and a plurality of light emitting diodes (22). The housing includes a plurality of fins (24), a base plate (211) and at least three sidewalls (212) extending out from a first main side of the base plate. The base plate and the sidewalls cooperatively defines a cavity (213). The fins are extended from a second main side of the housing. The fins are configured for dissipating heat from the housing. The fins and the housing are integrally formed. The at least one circuit board is disposed in the cavity of the housing. The light emitting diodes are disposed on the at least one circuit board. The backlight module is easy to be assembled and has low cost.

### BACKGROUND OF THE INVENTION

1. Field of the Invention

The present invention generally relates to backlight modules and, more particularly, to a direct type backlight module with light emitting diodes (LEDs) light sources, typically used in a liquid crystal display (LCD) device.

2. Discussion of the Related Art

Most liquid crystal display (LCD) devices are passive devices in which images are displayed by controlling an amount of light rays input from an outside light source. Thus, a separate light source (for example, a backlight module) is generally employed for illuminating an LCD panel that includes the LCD device.

Generally, backlight modules can be classified into edge type backlight modules and direct type backlight modules, based upon the arrangement of lamps within the backlight module. The edge type backlight module has a lamp arranged at a side portion of a light guiding plate for guiding light. An edge type backlight module is commonly employed in small-sized LCDs due to it being compact and lightweight, and having low power consumption. However, in general the edge type backlight module is not suitable for large-sized LCDs (20 inches or more). The direct type backlight module has a plurality of lamps arranged in a regular array to directly illuminate an entire main input surface of an LCD panel. The direct type backlight module has a higher efficiency of utilization of light energy and a longer operational service life than the edge type backlight module. The direct type backlight module is particularly suitable for large-sized LCDs.

The lamps of the direct type backlight module can be selected from the group consisting of cold cathode fluorescent lamps (CCFLs) and light emitting diodes (LEDs). LEDs have purer color and a lower operation voltage than CCFLs, and are also lightweight. Thus LEDs are more commonly used in direct type backlight modules. However, LEDs generate much heat energy when emitting light. For example, in LEDs with substrate materials of GaN (gallium nitride), 10% of electric energy is converted to light energy and 90% of electric energy is converted to heat energy. Thus heat dispersion is very important with LEDs, particularly LEDs employed in direct type backlight modules.

Referring to FIG. 9, a typical direct type backlight module 10 is shown. The backlight module 10 includes a housing 11, a plurality of LEDs 12 acting as light sources, a circuit board 13, a reflective sheet 14, two heat sink modules 15, a light diffusion plate 16, a light diffusion plate 17, and a prism sheet 18. The housing 11 includes a bottom board 111, and four sidewalls 112 perpendicular to the bottom board 111. The bottom board 111 and the sidewalls 112 cooperatively define a receiving space 113. The circuit board 13 is received in the receiving space 113 on the bottom board 111. The LEDs 12 are arranged on the circuit board 13. The reflective sheet 14 is disposed above and is spaced from the circuit board 13. The heat sink modules 15 are mounted at an outer surface of the bottom board 111 by a plurality of bolts (not shown). A heat transferring layer 19 is provided between the bottom board 111 and each of the heat sink modules 15. The light diffusion plate 16, the light diffusion plate 17, and the prism sheet 18 are arranged on top of the housing 11 in that order.

In the above-described backlight module 10, the heat sink modules 15 are mounted to the housing 11 by the bolts. Thus, assembly of the backlight module 10 is relatively complicated. Furthermore, the heat transferring layers 19 are needed in addition to the heat sink modules 15, which makes the cost of the direct type backlight module 10 unduly high.

Therefore, a new backlight module is desired in order to overcome the above-described shortcomings.

### SUMMARY

An exemplary backlight module includes a housing includes a one-piece housing, at least one circuit board, and a plurality of light emitting diodes. The one-piece housing includes a base plate, at least three sidewalls, and a plurality of fins. The at least three sidewalls are extended from a first main side of the base plate. The base plate and the sidewalls cooperatively defines a cavity. The fins are extended from a second main side of the base plate for dissipating heat from the housing. The at least one circuit board are disposed in the cavity of the housing. The light emitting diodes are disposed on the at least one circuit board.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present backlight module. Moreover, in the drawings, like reference numerals designate corresponding parts throughout the several views, and all the views are schematic.

FIG. 1 is an exploded, isometric view of a backlight module in accordance with a first embodiment of the present invention.

FIG. 2 is a cross-sectional view of the backlight module of FIG. 1 when assembled, corresponding to line II-II thereof.

FIG. 3 is a side cross-sectional view of a backlight module in accordance with a second embodiment of the present invention.

FIG. 4 is a side cross-sectional view of a backlight module in accordance with a third embodiment of the present invention.

FIG. 5 is a side cross-sectional view of a backlight module in accordance with a fourth embodiment of the present invention.

FIG. 6 is a side cross-sectional view of a backlight module in accordance with a fifth embodiment of the present invention.

FIG. 7 is a side cross-sectional view of a backlight module in accordance with a sixth embodiment of the present invention.

FIG. 8 is a side cross-sectional view of a backlight module in accordance with a seventh embodiment of the present invention.

FIG. 9 is a side cross-sectional view of a conventional backlight module.

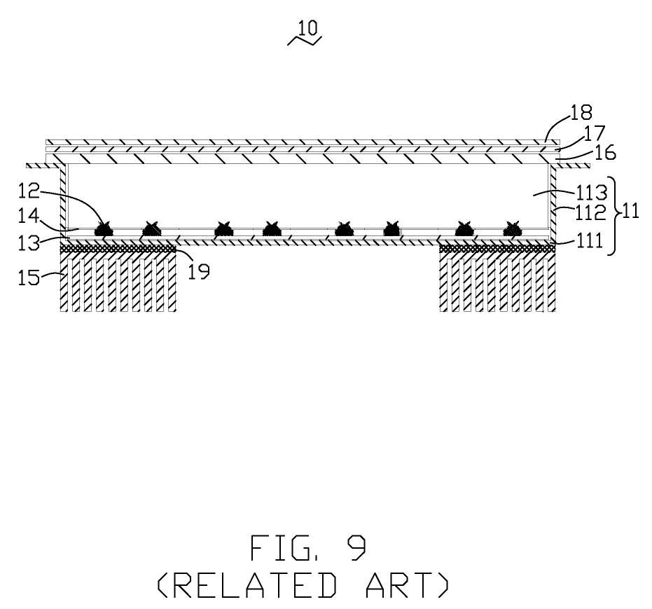

### DETAILED DESCRIPTION OF THE EMBODIMENTS

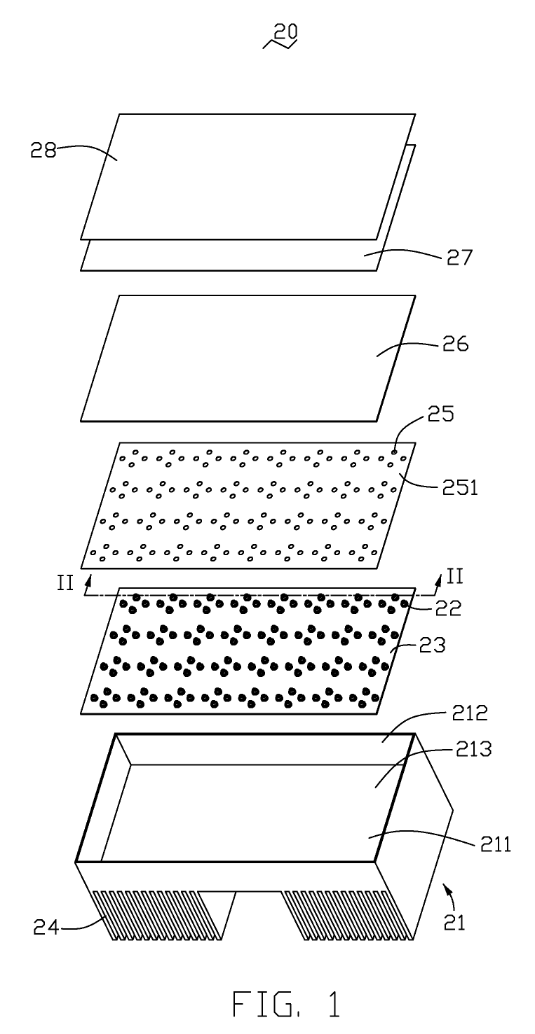

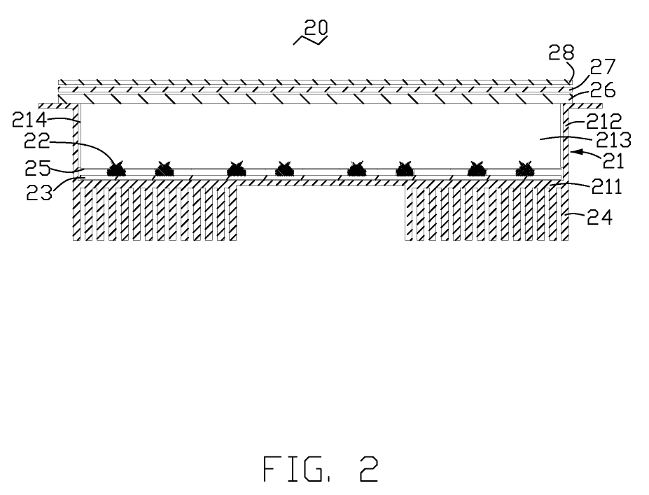

Referring now to the drawings in detail, FIG. 1 and FIG. 2 show a direct type backlight module 20 according to a first preferred embodiment. The backlight module 20 includes a housing 21, a plurality of LEDs 22 acting as light sources, and a circuit board 23. Alternatively, the LEDs 22 may also be other kinds of light sources such as CCFLs.

The housing 21 includes a base plate 211, and four sidewalls 212 perpendicularly extending from a periphery of the base plate 211. The base plate 211 and the sidewalls 212 cooperatively define a cavity 213. A plurality of fins 24 is formed in a predetermined pattern beneath the base plate 211. The fins 24 are arranged in two groups, at two opposite ends of the housing 21 underneath the cavity 213. The fins 24 and the housing 21 are integrally formed by high pressure diecasting technology or compression molding technology. The fins 24 are made of material with high thermal conductivity, such as aluminum alloy, magnesium alloy, or aluminum-magnesium alloy. The circuit board 23 is disposed in the cavity 213 of the housing 21 in contact with the base plate 211. The LEDs 22 are disposed on the circuit board 23 in a predetermined array. In alternative embodiments, the housing 21 may include only three sidewalls, or more than four sidewalls.

In the backlight module 20, because the fins 24 and the housing 21 are integrally formed, heat can be transferred from the housing 21 to the fins 24. In addition, unlike in the above-described conventional backlight module 10, no heat transferring layer is required. Furthermore, unlike in the above-described conventional backlight module 10, there is no need for a procedure of attaching the fins 24 to the housing 21 by bolts. Therefore, assembly of the backlight module 20 is simple.

Further, referring to FIG. 2, each of inner surfaces of the sidewalls 212 of the housing 21 can be coated with a high reflectivity film 214 for reflecting light rays emitted from the LEDs 22.

The backlight module 20 also includes a reflective sheet 25. The reflective sheet 25 defines a plurality of through holes 251. The reflective sheet 25 is received in the cavity 213 of the housing 21. Each of the LEDs 22 includes a light output portion (not labeled) at a top thereof. The light output portions of the LEDs 22 are exposed above the through holes 251 of the reflective sheet 25 respectively. Thus the reflective sheet 25 is positioned above the circuit board 23 while still providing full reflection capability.

The backlight module 20 further includes at least one optical sheet. That is, the backlight module 20 may employ more than one optical sheet. For example, a combination of optical sheets may include at least one light diffusion plate, at least one prism sheet, and at least one brightness enhancement layer. In this embodiment, the backlight module 20 includes a first diffusion plate 26, a second diffusion plate 27, and a prism sheet 28 disposed on top of the housing 21 in that order. The first diffusion plate 26 is configured to diffuse light rays emitted from the LEDs 22 so as to enhance a uniformity of the light rays. The second diffusion plate 27 is configured to further diffuse light rays emitted from the first diffusion plate 26. The prism sheet 28 is configured to collect the light rays from the second diffusion plate 27, so that a spread angle of light rays emitted from the backlight module 20 is approximately 70 degrees. Therefore, a brightness of the backlight module 20 is enhanced.

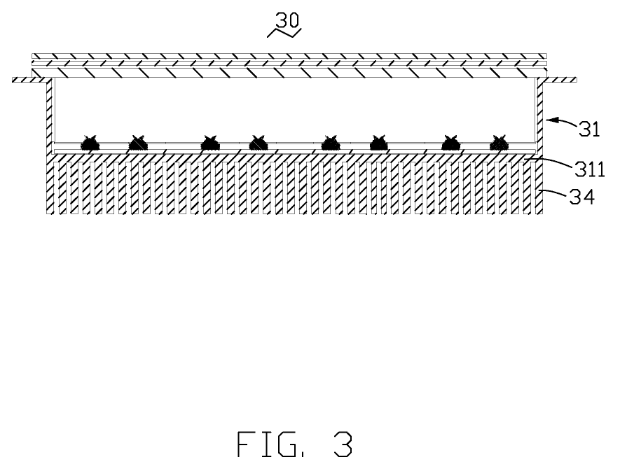

Referring to FIG. 3, a backlight module 30 according to a second embodiment is shown. The backlight module 30 is substantially the same as the backlight module 20 of the first embodiment, except that a plurality of fins 34 is formed throughout an entire expanse of a base plate 311 of a housing 31.

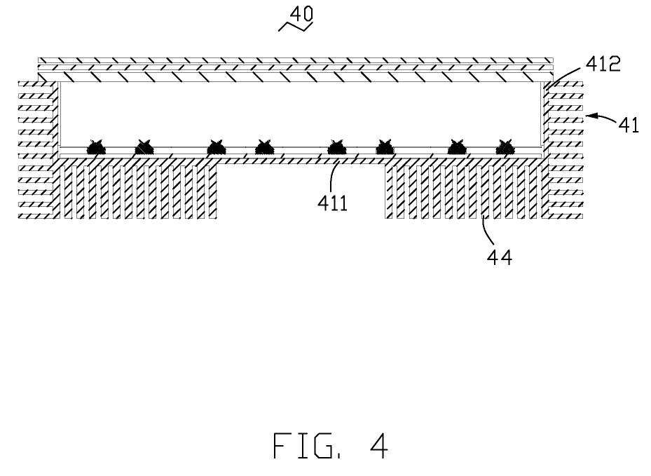

Referring to FIG. 4, a backlight module 40 according to a third embodiment is shown. The backlight module 40 is substantially the same as the backlight module 20 of the first embodiment. However, the backlight module 40 includes a housing 41. The housing 41 includes a base plate 411, and four sidewalls 412 perpendicularly extending from a periphery of the base plate 411. A plurality of fins 44 is formed in a predetermined pattern beneath the base plate 411, and on an outer surface of each sidewall 412. The fins 44 formed on the base plate 411 are disposed at two opposite sides of the base plate 411.

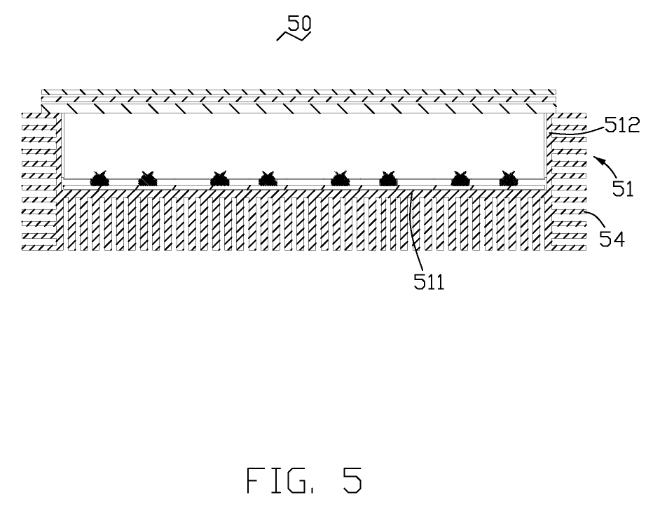

Referring to FIG. 5, a backlight module 50 according to a fourth embodiment is shown. The backlight module 50 is substantially the same as the backlight module 20 of the first embodiment. However, the backlight module 50 includes a housing 51. The housing 51 includes a base plate 511, and four sidewalls 512 perpendicularly extending from a periphery of the base plate 511. A plurality of fins 54 is formed throughout an entire expanse of the base plate 511, and on an outer surface of each of the sidewalls 512.

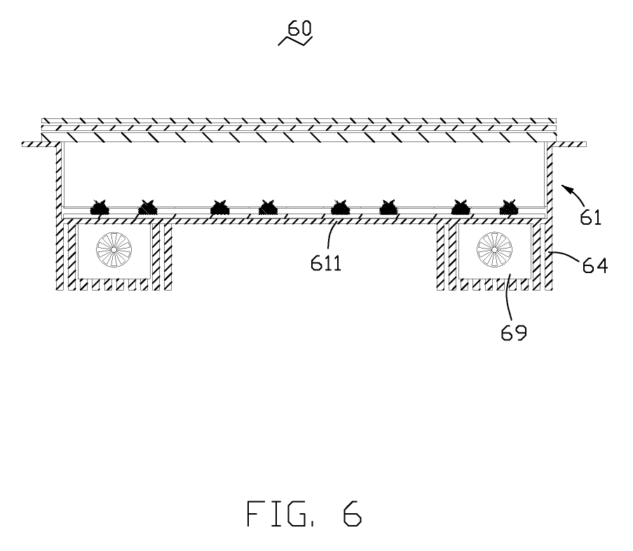

Referring to FIG. 6, a backlight module 60 according to a fifth embodiment is shown. The backlight module 60 is substantially the same as the backlight module 20 of the first embodiment, except that a plurality of electric fans 69 are provided corresponding to two groups of fins 64. The fans 69 are configured to accelerate a flow of air so that heat can be dispersed more efficiently from the fins 64. In the illustrated embodiment, the fans 69 are provided in receptacles defined in the groups of fins 64, respectively.

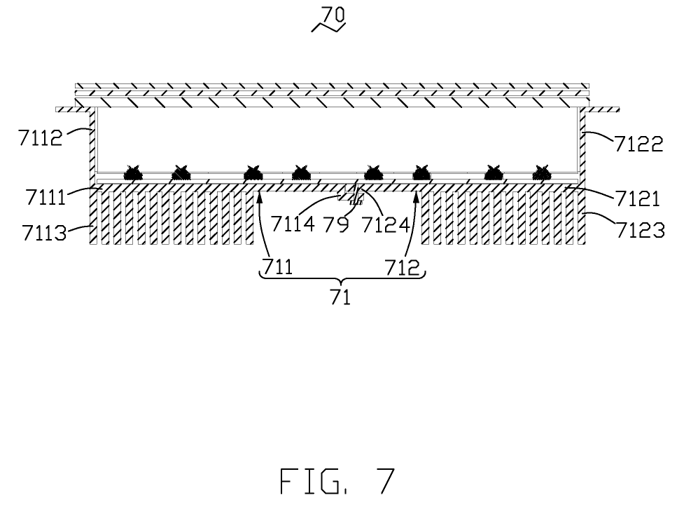

Referring to FIG. 7, a backlight module 70 according to a sixth embodiment is shown. The backlight module 70 is substantially the same as the backlight module 20 of the first embodiment, except that the backlight module 70 includes a housing 71. The housing 71 comprises a first unit 711 and a second unit 712, which are complementary to each other. The first unit 711 includes a first base plate 7111 having four edges. Three sidewalls 7112 perpendicularly extend from three of the edges of the first base plate 7111, respectively. A plurality of fins 7113 is formed beneath the first base plate 7111. The fins 7113 are disposed at one end of the first base plate 7111 distal from the second unit 712. The edge of the first base plate 7111 without a sidewall 7112 extending therefrom forms a bending portion 7114. The second unit 712 includes a second base plate 7121 having four edges. Three sidewalls 7122 perpendicularly extend from three of the edges of the second base plate 7121, respectively. A plurality of fins 7123 is formed beneath the second base plate 7121. The fins 7123 are disposed at one end of the second base plate 7111 distal from the first unit 711. The edge of the second base plate 7121 without a sidewall 7122 extending therefrom forms a protruding portion 7124. At least one bolt 79 is provided to connect the first unit 711 and the second unit 712. That is, the at least one bolt 79 is threadingly engaged in the bending portion 7114 and the protruding portion 7124, whereby the first and second units 711, 712 are attached together. Thereby, the housing 71 with a composite base plate and four sidewalls (including two composite sidewalls) is formed. The first unit 711 and the fins 7113 are integrally formed, and the second unit 712 and the fins 7123 are integrally formed. In alternative embodiments, the first unit 711 and the second unit 712 may be connected together by riveting or welding. In another alternative embodiment, the housing 71 may be constituted by three or more units connected together. Large-sized backlight modules can employ the housing 71 with more than one unit because large-sized housings are difficult to be manufactured.

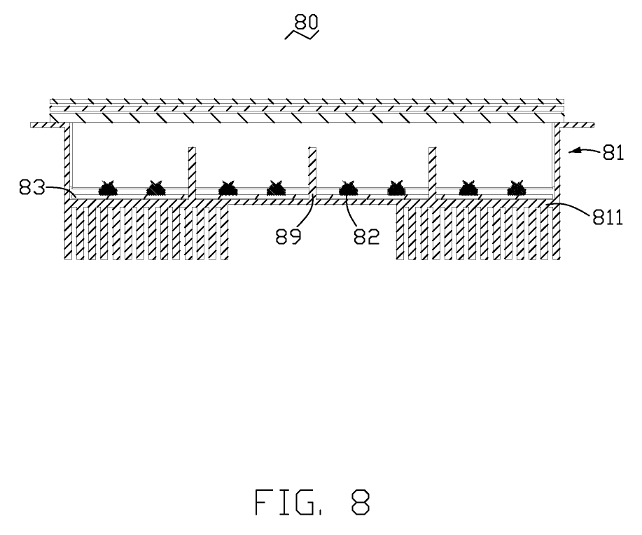

Referring to FIG. 8, a backlight module 80 according to a seventh embodiment is shown. The backlight module 60 is substantially the same as the backlight module 20 of the first embodiment. However, in the backlight module 80, a plurality of partitions 89 are formed on a base plate 811 of a housing 81. Correspondingly, the backlight module 80 includes a plurality of circuit boards 83. The partitions 89 are disposed inside the housing 81. The partitions 89 are evenly spaced apart from one another, and are perpendicular to the base plate 811. The circuit boards 83 are separated from one another by the partitions 89. A plurality of LEDs 82 are disposed in a cavity (not labeled) of the housing 81. The LEDs 82 can be colored LEDs 82 having selected colors. The LEDs 82 are partitioned into a plurality of light-mixing units by the clipboards 89. Each light-mixing unit is mounted on one corresponding circuit board 83. With this configuration, the LEDs 82 of each light-mixing unit can be controlled by the corresponding circuit board 83, either independently of the other light-mixing units or in coordination with selected one or more of the other light-mixing units. Thereby, the LEDs 82 of the light-mixing units can have different colors and levels of brightness as desired. Further, a reflective layer is coated on all exposed portions of each of the partitions 89.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A direct type backlight module, comprising:
a one-piece housing comprising:
a base plate;
at least three sidewalls extending from a first main side of the base plate, the base plate and the sidewalls cooperatively defining a cavity; and
a plurality of fins extending from a second main side of the base plate, wherein the fins are configured for dissipating heat from the housing;
at least one circuit board disposed in the cavity of the housing; and
a plurality of light emitting diodes disposed on the at least one circuit board.

2. The direct type backlight module as claimed in claim 1, wherein the housing is a high pressure diecasted housing or a compression molded housing.

3. The direct type backlight module as claimed in claim 1, wherein the fins are made of material with high thermal conductivity selected from the group consisting of aluminum alloy, magnesium alloy, and aluminum-magnesium alloy.

4. The direct type backlight module as claimed in claim 1, wherein the at least one circuit board is mounted on the base plate of the housing.

5. The direct type backlight module as claimed in claim 1, wherein the fins are arranged in two groups at two opposite ends of the base plate of the housing, and the fins perpendicularly extend from the base plate of the housing.

6. The direct type backlight module as claimed in claim 5, wherein the housing further comprises a plurality of fins extending from an outer surface of at least one of the at least three sidewalls, and the fins extending from the outer surface of at least one of the at least three sidewalls are configured for dissipating heat from the housing.

7. The direct type backlight module as claimed in claim 1, wherein the fins perpendicularly extend from substantially an entire area of the base plate of the housing.

8. The direct type backlight module as claimed in claim 7, wherein the housing further comprises a plurality of fins extending from an outer surface of at least one of the at least three sidewalls, and the fins extending from the outer surface of at least one of the at least three sidewalls are configured for dissipating heat from the housing.

9. The direct type backlight module as claimed in claim 1, further comprising at least one fan operatively associated with the fins.

10. The direct type backlight module as claimed in claim 1, wherein the housing further comprises at least one partition disposed in the cavity and extending from the first main side of the base plate, the at least one circuit board is a plurality of circuit boards, the circuit boards are separated from one another by the at least one partition, and the light emitting diodes are partitioned by the at least one partition into at least two light-mixing units.

11. The direct type backlight module as claimed in claim 1, further comprising a high reflectivity film coated on inner surfaces of the at least three sidewalls of the housing, the high reflectivity film configured for reflecting light rays emitted from the light emitting diodes.

12. The direct type backlight module as claimed in claim 1, further comprising a reflective sheet disposed in the cavity above the at least one circuit board, wherein the reflective sheet defines a plurality of through holes, each of light emitting diode comprises an upper illuminating portion, and the illuminating portion is exposed above a respective one of the through holes of the reflective sheet.

13. The direct type backlight module as claimed in claim 12, further comprising at least one optical sheet disposed on top of the housing over the cavity.

14. The direct type backlight module as claimed in claim 1, wherein the at least one optical sheet comprises at least one item selected from the group consisting of a light diffusion plate, a prism sheet, and a brightness enhancement layer.

15. A direct type backlight module, comprising:
a housing being comprising at least two complementary one-piece units, the at least two one-piece units comprising:
a first one-piece unit comprising:
a first base plate having at least three edges, and at least two sidewalls extending from at least two of the at least three edges of first base plate in a first direction; and
a plurality of fins extending from the first base plate in a second direction, the second direction being opposite to the first direction, the fins configured for dissipating heat from the housing;
a second one-piece unit comprising:
a second base plate having at least three edges, and at least two sidewalls extending from at least two of the at least three edges of second base plate in the first direction; and
a plurality of fins extending from the second base plate in a second direction, the fins configured for dissipating heat from the housing;
wherein the first one-piece unit and the second one-piece unit are connected together, and the at least two complementary one-piece units cooperatively define a cavity of the housing;
at least one circuit board disposed in the cavity of the housing; and
a plurality of light emitting diodes disposed on the at least one circuit board.

16. The direct type backlight module as claimed in claim 15, further comprising at least one fastener, wherein each of the at least two one-piece units comprises a connecting portion, and the at least one fastener interconnects the first one-piece unit and the second one-piece unit by engaging in the connecting portions of the first one-piece unit and the second one-piece unit.

17. The direct type backlight module as claimed in claim 16, wherein the connecting portion of the first one-piece unit is a bending portion formed at the edge of the at least three edges not having a sidewall extending therefrom, and the connecting portion of the second one-piece unit is a protruding portion formed at the edge of the at least three edges not having a sidewall extending therefrom.

18. The direct type backlight module as claimed in claim 15, wherein the at least two one-piece units are connected together by welding or riveting.

19. The direct type backlight module as claimed in claim 15, wherein the housing further comprises at least one partition disposed in the cavity and extending from at least one of the first base plate of the first one-piece unit and the second base plate of the second one-piece unit, the at least one circuit board is a plurality of circuit boards, the circuit boards are separated from one another by the at least one partition, and the light emitting diodes are partitioned by the at least one partition into at least two light-mixing units.
